(19) United States
(12) Patent Application Publication
(10) Pub. No.: US 2009/0081806 A1
(43) Pub. Date: Mar. 26, 2009

(54) Methods and Compositions for pH Control

(76) Inventors: Charles E. Reeves, III, Marietta, GA (US); Alan Sumner, Conyers, GA (US)

Correspondence Address: TROUTMAN SANDERS LLP;RYAN A. SCHNEIDER, ESQUIRE, 600 PEACHTREE STREET , NE, 5200 BOA PLAZA, ATLANTA, GA, 30308, US

(21) Appl. No.: 12/084,176

(22) PCT Filed: Oct. 30, 2006
(86) PCT No.: PCT/US06/42219

§ 371 Date: Apr. 25, 2008

Related U.S. Application Data
(60) Provisional application No. 60/731,120, filed on Oct. 28, 2005.

(51) Int. Cl. G01N 31/22

(52) U.S. Cl. 436/163

(57) ABSTRACT

The present invention comprises methods and compositions for controlling the pH of a confined body of water, such as a swimming pool, spas, and hot tubs, using an organic acid specifically citric acid alone or in combination with other organic acids, borates or boric acid or other chelants or clarifiers. The amount of organic acid added to the confined body of water is determined relative to the pH of the water prior to such addition and the volume of water being treated. The amount of maintenance doses of organic acid is based upon the volume of water being treated and the magnitude of pH change required for adjustment to desired pH. The organic acid can be dispensed automatically or manually and can be dispensed as a solid, including a dispersable powder form, a capsule, or tablet, or as a liquid concentrate to be diluted in the confined body of water.

### FIELD OF THE INVENTION

The invention relates to methods and compositions for confined bodies of water using an organic acid.

### BACKGROUND OF THE INVENTION

Recreational waters such as commercial or recreational pools, spas, and hot tubs provide a great deal of pleasure and comfort. The extent of comfort and safety depends on the quality of water. In order to assure comfort and safety to users of these confined bodies of water, it is important that the water be sanitized properly and that it be aesthetically pleasing in terms of taste, color, turbidity, and odor. Proper treatment includes maintaining the proper pH, and assuring that the water is environmentally safe as well as effectively sanitized to prevent the spread of pathogenic microorganisms.

Maintenance of sanitary and aesthetic conditions of confined bodies of water generally requires addition of chemical agents to control microbial growth. Halogen chemicals are frequently the chemical agents of choice. All of the halogens are bactericidal and virucidal, and iodine, bromine, and chlorine are all recognized as effective water sanitizers. However, because of its availability and economy, chlorine is used extensively for sanitization of confined bodies water, including swimming pools, spas and hot tubs, cooling towers, air conditioning units and other industrial applications. Due to constant contamination of the water from dust, rain, and in particular, the human body, and depletion due to sunlight, chlorine must be regularly added to the water to kill pathogens and control algae.

The effectiveness of the chlorine is dependent upon the pH of the water. Proper pH balance of the water is important with respect to the disinfecting effect of the chlorine and physical effects on the bathers. Chlorine is consumed in the process of sanitizing by chemical reaction with organic materials as well as depletion by sunlight. Chlorine is also less stable as the pH is lowered. Therefore, in order to maintain an effective level of chlorine in the pool for disinfection, chlorine is replenished by chlorination of the pool water. Chlorination of water is generally accomplished by the addition of chlorine either as a gas or liquid, or in the form of hypochlorite powder. Normally, chlorination of water is carried out by introducing hypochlorite directly to the water, either using a solution containing sodium hypochlorite or as granular calcium hypochlorite. Both of these compounds are alkaline in nature and will increase the pH of the water. It is well documented that chlorine is much less effective as a germicide under increasing pH conditions as hypochlorite becomes the dominant species. As the pH is lowered, hypochlorous acid predominates. Hypochlorous acid is 100 times more potent a germicide than hypochlorite. In order to prevent hypochlorite formation, the pH of the water is regulated from 7.4-7.8 to aid in the presence of hypochlorous acid. (see “Handbook of Chlorination” by C. White, Van Nostrand Reinhold, New York, N.Y.). This is commonly accomplished by the addition of muriatic acid.

Despite the effectiveness and historical use of products such as muriatic acid or of sodium bisulfate for pH adjustment and control in recreational pools, spas, and hot tubs, there remain disadvantages to their continued use as well as new issues. These materials are currently listed as hazardous, corrosive materials by The Department of Transportation, and therefore, their transportation requires specialized packing, handling and labeling. With new concerns for public safety raised by Homeland Security, the use of these hazardous materials for pH adjustment is impacted by increased tracking of materials, costs of transport and storage. Furthermore, a large number of recreational pools, spas, and hot tubes are maintained by consumers rather than professional technicians, and this exposes adults and children to highly corrosive and poisonous materials.

A need therefore exists for methods and compositions for pH control of confined bodies of water such as commercial and recreational pools, spas, and hot tubs that include acids that are safe for transportation and use. A need exists for compositions and methods that provide for both public safety and safety for those using compositions for treatment of water.

### SUMMARY OF THE INVENTION

The present invention comprises methods and compositions for pH balance of confined bodies of water. The methods comprise treatments of confined bodies of water including but not limited to, commercial and recreational pools, spas and hot tubs, and drinking water reservoirs, industrial waters such as cooling towers and the like. In an aspect of the present invention, the invention comprises methods of treatment of confined bodies of water such as recreational pools, spas and hot tubs with a composition comprising an organic acid to adjust, maintain and control the pH. Such methods are effective in combined bodies of water that are treated with chlorine, bromine or other sanitizing agents, and aids in the sanitization of the water, increases the buffering capacity, and provides aesthetically pleasing levels of properties such as enhanced clarity of the water.

In another aspect, the invention comprises methods of treatment of confined bodies of water such as recreational pools, spas and hot tubs with a composition comprising an organic acid that is listed on the U.S. Food and Drug Administration (FDA) list of generally recognized as safe (GRAS) substances to adjust and control the pH to achieve optimal sanitization such as by chlorination or other types of sanitization of the water, increased buffering capacity, and to provide aesthetically pleasing levels of properties such as enhanced clarity of the water.

The present invention comprises methods of providing compositions of the invention to confined bodies of water, including but not limited to, commercial and residential pools, lap pools, fountains, spas and hot tubs, cooling towers, drinking water reservoirs, and industrial waters. The present invention is contemplated as being used in any confined body of water wherein pH is desirably maintained at a stable value, the growth of microorganisms is desirably inhibited, and the clarity of the standing water system is desirably maintained. Compositions may comprise at least one organic acid in amounts effective for balancing the pH of a confined body of water.

### DETAILED DESCRIPTION OF THE INVENTION

The present invention comprises methods and compositions for maintaining confined bodies of water in pleasant and sanitary conditions. The methods of the present invention comprise methods for treating confined bodies of water with compositions taught herein, methods of making the compositions and methods of using the compositions in treating confined bodies of water. Compositions of the present invention comprise at least one organic acid in a delivery composition.

The methods of the present invention comprise creation of ideal conditions for confined bodies of water, and continued maintenance of those conditions. Creation and maintenance of such water conditions are achieved by treatment of the water to remove contaminants such as microbial growth, while not harming the humans or animals which might enter the water. Though the compositions, methods and systems are discussed herein in reference to swimming pool or spa water, it is understood that the compositions, methods and systems can also be used in hot tubs, spas, ponds, water cooling systems, humidification systems, and any confined bodies of water.

In general, confined bodies of water are maintained within particular pH ranges in order to provide an environment in which compounds in the water are effective for treatment of microbial contaminants and not corrosive for the structure and plumbing in which the water is confined, and not harmful to the humans or animals entering the water. In general, the pH range for waters used for swimming is from 7.2 to 7.8, or other ranges as may be required by municipalities or other regulatory agencies. Generally, a pH below 7.0 may result in skin or eye irritation. Above the pH range of 7.2 to 7.8 the sanitizing power of chlorine is greatly reduced and may result in skin and eye irritation. It is currently believed that the optimum balance of bactericidal efficiency and bather comfort occurs between 7.2 and 7.8.

When chlorine, Cl₂, dissolves in water, it hydrolyzes according to the reaction:

Cl₂+H₂O [symbol] HOCl+HCl

The chlorine of the hydrochloric acid does not contribute to the disinfection reaction. Rather, it is the hypochlorous acid, HOCl, which actually kills the microbial contaminants. The germicidal power of hypochlorous acid is attributed to its ability to defuse through cell walls and chemically react with proteins or nucleic acids within the cell or virus particle. The chemical action for disinfection is the same, that is, via hypochlorous acid, regardless of whether chlorine is added to water by chlorination.

Hypochlorous acid, being a weak acid, ionizes in water according to the equation:

HOCl [symbol] H⁺OCl⁻

The equilibrium is both instantaneous and reversible. The driving force affecting the overall equilibrium, that is the relative concentrations of hypochlorous acid (HOCl) and hypochlorite (OCl⁻), is the concentration of hydrogen ion (H⁺). The practical effect is that the ratio of hypochlorous acid and hypochlorite can be adjusted or manipulated by adjusting the concentration of hydrogen ion. The hydrogen ion concentration is usually expressed in terms of a pH value, where a lower pH value represents a higher concentration of hydrogen ion or a more acidic condition. Likewise, a higher pH value represents a lower hydrogen ion concentration or a more alkaline condition.

Thus, the equation shows that when the pH is lowered, that is, more acid or hydrogen ion is added to the system, the equilibrium is forced to the left and more hypochlorous acid is present. Conversely, when the pH is raised, the acid concentration or hydrogen ion concentration is lowered, the equilibrium is shifted to the right and more hypochlorite is present. Consequently, any free chlorine or hypochlorite added to water will immediately distribute itself into hypochlorous acid hypochlorite, with the ratio for the two being controlled entirely by the pH value of the water. In view of the great difference in killing power between hypochlorous acid and hypochlorite, the pH value becomes of the greatest importance with respect to disinfection. At the recommended pH of 7.4 to 7.8, or from 7.4 to 7.6, the relative concentrations of hypochlorous acid, hypochlorite, and hydrogen ion are in an optimal balance for both disinfection and comfort to the users of the pool.

The process of pool chlorination is not completed by addition of hypochlorite to the pool. First, the addition of hypochlorite itself tends to increase the pH of the water. Second, from the foregoing discussion of the equilibrium chemistry of hypochlorite and hypochlorous acid, it is apparent that following the addition of exogenous hypochlorite, the pH of the solution will need to be decreased to insure that the appropriate concentration of hypochlorous is present in the water. Conventionally, the pH is decreased in pool water by adding muriatic acid, also known as hydrochloric acid, or use of bisulfates that liberate sulfuric acid upon introduction to the pool water.

Unfortunately, most of these conventionally used chemicals are hazardous. For example, hydrochloric acid, or muriatic acid, is well known for causing accidental poisoning incidents involving mishandled pool chemicals. Contact with skin or membranes causes corrosion or burns, and prolonged exposure leads to chronic conditions.

The present invention comprises methods of establishing and maintaining the pH of a confined body water by administering an acidic composition comprising one or more organic acids that are approved by the Food and Drug Administration as GRAS, that are effective, non-toxic and safe for use in balancing the pH of bodies of water. The methods comprise administering organic acidulant compositions effective for balancing the pH of the body of water.

In one aspect the present invention comprises methods for establishing and maintaining pH of a confined body of water comprising administering organic acidulant compositions comprising alkyl, alkenyl, alkynyl, and aromatic organic acid compounds, wherein the carbon backbone comprises 1-24 carbon atoms. In another aspect, the organic acidulant compositions comprise organic acids that have 1, 2, 3, 4, 5, 6, 7, and 8 acid moieties.

Non-limiting examples of suitable saturated aliphatic dicarboxylic acids include oxalic acid, malonic acid, succinic acid, glutaric acid, adipic acid, pimelic acid, suberic acid, azelaic acid, sebacic acid and dodecanedioic acid. Non-limiting example of suitable unsaturated aliphatic dicarboxylic acids include maleic acid, fumaric acid and itaconic acid. Examples of suitable aromatic dicarboxylic acids are phthalic acids, such as terephthalic acid and isophthalic acid. Non-limiting examples of suitable substituted aliphatic dicarboxylic acids include malic acid and tartaric acid. A non-limiting example of a substituted aliphatic tricarboxylic acid is citric acid, and includes, but is not limited to, hydroxy carboxylic acids. Also useful in the present invention are dimer acids, which are high molecular weight dibasic dicarboxylic acids which are produced by dimerization of mixed unsaturated fatty acids, and similarly produced trimer acids which contain three carboxyl groups.

The compositions of the present invention comprise at least one organic acid that is noncorrosive to skin and membranes of humans, recognized as GRAS at 21 CFR Part 182 and 184, are biodegradeable, and will not generate irritating fumes as does muriatic acid. The compositions of the present invention may have the neutralizing power of muriatic acid and dry acid compositions currently used The compositions of the present invention that are in powder form are safer to handle and ship than are currently used pH adjusting powders, and are not listed as hazardous by any federal or international agency. The present invention's compositions are less corrosive to metals, and because they are biodegradeable, there are no sewer discharge issues. The compositions may comprise minor elements of organic and natural mineral ingredients, do not contain phosphates or phosphoric acid that would cause environmental contamination, do not require child resistant packaging, and are considered nontoxic by the Consumer Product Safety Council.

An aspect of the present invention comprises methods for pH establishment and maintenance using compositions comprising at least citric acid. Citric acid, C₆H₈O₇, CAS Reg. No. 77-92-9, is the compound 2-hydroxy-1,2,3-propanetricarboxylic acid. It is a naturally occurring constituent of plant and animal tissues. It occurs as colorless crystals or a white powder and may be anhydrous or contain one mole of water per mole of citric acid. In accordance with C.F.R. §184(b)(1), citric acid can be used in foods with no limitations other than current good manufacturing practice. As used herein, “food-safe organic acid” means an organic acid that is recognized as safe for inclusion in food with no limitations, as defined by U.S. regulations.

Compositions of the present invention may comprise dry powders or liquid solutions. Dry powders generally comprise approximately 80% to 100% of at least one organic acid that is recognized as GRAS and is biodegradeable, 0% to 20% of a borate and/boric acid, and optionally may comprise other ingredients such as fragrances, anti-caking materials, chelating materials, or other optional elements. Liquid solution compositions of the present invention may be provided in any concentration, but are more generally found in concentrations of 20-30% of at least one organic acid that is recognized as GRAS (Generally Recognized as Safe) and is biodegradeable, 0% to 20% of a borate and/or boric acid, and optionally may comprise other ingredients such as fragrances, emulsifiers, anti-caking compounds, etc. The borate of the present invention can be any alkaline metal borate, such as an alkaline metal tetraborate pentahydrate, an alkaline metal tetraborate dehydrate, or an alkaline metal tetraborate pentahydrate. The alkaline metal can be any alkaline metal that is compatible with the borate ion. These alkaline metals include sodium, potassium, and lithium. For example, the borate salt may comprise sodium tetraborate pentahydrate, sodium tetraborate octahydrate, sodium tetraborate decahydrate, lithium tetraborate pentahydrate, or potassium tetraborate octahydrate. Boric acid alone can be used in the present invention. If a combination of borate and boric acid is used, the combination of alkaline metal borate and boric acid can be in the ratio of 5% to 95% borate to boric acid by weight. Again, it is contemplated that by the term borate, as used herein, the borate can be any of the borate ions or it can be a combination of one or more of the borate ions and boric acid. Such optional agents are known for use in formulating powder or liquid compositions.

For example, a composition may comprise a dry powder form comprising approximately 90-100% crystalline citric acid, and optionally other ingredients disclosed herein, or a composition may comprise a dry powder form comprising approximately 90-100% anhydrous citric acid, and optionally other ingredients disclosed herein. Alternatively, a composition may comprise a dry powder form comprising approximately 80-100% crystalline citric acid or anhydrous citric acid, and optionally other ingredients disclosed herein, and 0-20% borate or boric acid.

Methods of the present invention comprise adjusting or maintaining the pH of a confined body of water comprising adding an effective amount of a composition comprising an organic acid. The organic acid may be an alkyl di or tricarboxylic acid of the form HO₂C(CH₂)ₙCO₂H wherein n may be 1, 2, 3 or 4. The organic acid may be RC(CH₂CO₂H)CO₂H wherein R may be —H, —OH, or —CH₃. The organic acid may be citric acid. The organic acid may be ethylenediamine tetraacetic acid or ethylene-bis(beta-aminoethylether)-N,N-tetraacetic acid. The organic acid may be an alpha amino acid containing a gamma carboxylic acid group. The organic acid may be either aspartic acid or glutamic acid. The method may comprise adjusting the pH in water using specific ratios of an organic acid and its conjugate base. The method may comprise adjusting the pH in a confined body of water using specific ratios of citric acid and the conjugate base of the alkali or alkaline earth salt form of citric acid.

Methods of the present invention also comprise treatment of surfaces for removal of iron and metallic stains comprising applying the compositions taught herein. The methods of the present invention comprise administering the compositions of the present invention comprising an organic acid to chelate metals in the water. The methods of the present invention also comprise administering the compositions of the present invention to provide improved clarity to the body of water.

Methods of the invention comprise using the compositions taught herein for maintaining and establishing confined bodies of water. Methods for establishing a pool or spa are well known. In general, in stabilizing the pH, testing is performed and an appropriate amount of a composition taught herein is added, the water is retested, and the steps are repeated until the appropriate pH is reached. In established water systems, pH is maintained on a regular basis by regular testing methods and addition of compositions taught herein as needed. For example, the pH of a pool is desired to be between 7.2 to 7.8. If a test kit indicates a reading greater than 7.8, a manual addition of approximately 12 ounces of a dry composition comprising 80% to 100% of at least one organic acid that is recognized as GRAS and is biodegradeable, 0% to 20% of a borate and boric acid, and optionally may comprise other ingredients such as fragrances, anti-caking materials, chelating materials, or other optional elements directly into the pool for every 10,000 gallons of water. Wait two hours and re-test. If pH is still greater than 7.8, repeat application.

If the Taylor Drop test method is used, when using a Taylor Acid Demand Test Kit, the following chart could apply for adding the above compositions, for example, a dry composition comprising 95% citric acid and 5% borate or boric acid; or 100% citric acid.

| No. of | | | | |
|---|---|---|---|---|
| Drops | 10K gal pool | 20K gal pool | 30K gal pool | 50K gal pool |
| 1 | 0.75 lb | 1.5 lb | 2.25 lb | 3.75 lb |
| | composition | composition | composition | composition |
| 2 | 1.5 lb | 3.0 lb | 4.5 lb | 6.0 lb |
| | composition | composition | composition | composition |
| 3 | 2.25 lb | 6 lb | 9.0 lb | 12 lb |
| | composition | composition | composition | composition |

Methods of the present invention affect pH of confined bodies of water. pH is an important element of water chemistry and affects the chemical balance of the water. In swimming pools, a slightly alkaline pH of 7.4 to 7.6 is comfortable to the human eye and provides for use of free chlorine while maintaining water that is not corrosive or scale forming.

If the pH of the water is too low (below 7.0), the water becomes acidic, the chlorine residuals dissipate rapidly, eye irritation occurs, plaster walls are etched, metal fittings, the pump impeller, and the heater core may corrode and the dissolved metals may leave stains on walls and there may be a rapid loss of alkalinity. On the other hand, if the pH is too high (above 8.0), chlorine activity is slowed and inefficient, scale formation and discoloration of pool walls, water becomes cloudy, the filter is overworked, and eye and skin irritation may occur.

The pH is generally adjusted after testing. If the pH is too low, run an alkali demand test if available. Raise the pH by adding soda ash (sodium carbonate). Usually, no more than 2 lbs per 10,000 gallons are added in a single treatment. The pump should be running when chemicals are added. Allow the water to recirculate for a time period and then retest to determine if further treatment is necessary. Caustic soda (sodium hydroxide) is sometimes used with chemical feed pumps to raise pH. If problems with low pH persist, it may be necessary to raise total alkalinity to stabilize the pH.

If the pH is too high, run an acid demand test if available. The pH is lowered by adding a composition taught herein. For example, add a liquid composition to a swimming pool comprising 20-30% of at least one organic acid that is recognized as GRAS and is biodegradeable, such as citric acid, 0% to 20% of a borate and/or boric acid, and optionally may comprise other ingredients such as fragrances, emulsifiers, etc., referred to below as citric acid composition.

Lowering pH with Citric Acid Composition
If pH is over 7.6, add this amount of acid, then retest.

| | GALLONS IN POOL | | | | | | | | | | | | | |
|---|---|---|---|---|---|---|---|---|---|---|---|---|---|---|
| pH | 1,000 | | 5,000 | | 10,000 | | 15,000 | | 20,000 | | 25,000 | | 50,000 | |
| 7.6-7.8 | 1¼ | oz. | 6 | oz. | 12 | oz. | 18 | oz. | 24 | oz. | 1 | qt. | 2 | qts. |
| 7.8-8.0 | 1½ | oz. | 8 | oz. | 16 | oz. | 24 | oz. | 1 | qt. | 1¼ | qts. | 2½ | qts. |
| 8.0-8.4 | 2½ | oz. | 12 | oz. | 24 | oz. | 1¼ | qts. | 1½ | qts. | 2 | qts. | 1 | gal. |
| Over 8.4 | 3 | oz. | 16 | oz. | 1 | qt. | 1¼ | qts. | 2 | qts. | 2½ | qts. | 1¼ | gal. |

The present invention comprises a method for establishing the pH in confined water, comprising, a) adding an effective amount of a composition comprising an organic acid and borate or boric acid to a confined body of water, and b) testing the resulting pH of the water. The organic acid may be an alkyl dicarboxylic acid of the form HO₂C(CH₂)ₙCO₂H wherein n may be 1, 2, 3 or 4. The organic acid may be RC(CH₂CO₂H)CO₂H wherein R may be —H, —OH, or —CH₃. The organic acid may be citric acid. The organic acid may be either ethylenediamine tetraacetic acid or ethylene-bis(beta-aminoethylether)-N,N-tetraacetic acid. The organic acid may be an alpha amino acid containing a gamma carboxylic acid group. The alpha amino acid may be either aspartic acid or glutamic acid. The composition may be a dry powder comprising 80 to 100% organic acid, and 0-20% borate or boric acid. The dry powder composition may comprise 95% citric acid and 5% boric acid.

The present invention comprises a method for establishing the pH in a confined body of water, comprising, a) adding to a confined body of water an effective amount of a composition comprising a food-safe organic acid recognized as GRAS; and b) testing the pH of the water. The food-safe organic acid recognized as GRAS may be citric acid. The composition further comprises borate or boric acid. The food-safe organic acid may be in a concentration of 80-100%. The concentration of borate or boric acid may be 0 to 20%. The composition optionally comprises fragrances, emulsifiers, or anti-caking compounds. The composition comprises borate and boric acid in a ratio of 5% to 95% borate to boric acid by weight. The composition may be a dry powder of 95% citric acid and 5% boric acid.

The present invention comprises a method for maintaining the pH of a contained body of water, comprising, a) testing the pH of the confined body of water; b) optionally, adding to a confined body of water an effective amount of a composition comprising a food-safe organic acid recognized as GRAS to bring the confined body of water to a desired pH; and c) testing the pH of the water. The food-safe organic acid recognized as GRAS may be citric acid. The composition further comprises borate or boric acid.

As used herein, the term “parts per million” is a unit of concentration representing one part of a chemical substance dissolved in one million parts of water. For example, one pound of ordinary table salt in one million pounds of water (approximately 120,000 gallons) would equal 1 ppm salt. In the metric system, 1 ppm equals 1 milligram per liter.

As used herein, the term “polycarboxylic acid” means an organic acid containing two or more carboxyl (—COOH) groups, and includes for example dicarboxylic acids, tricarboxylic acids and other polycarboxylic acids. Suitable polycarboxylic acids are preferably aliphatic, but the polycarboxylic acids can be aromatic and heterocyclic, if desired. The polycarboxylic acids can be saturated or unsaturated; and substituted or unsubstituted.

### EXAMPLES

### Example 1

Four 10 gallon tanks were established and maintained for 1 month to simulate standing bodies of water, pools, and were balanced to pool water specifications. Liquid sodium hypochlorite was used as the chlorine source and added as needed once a day to maintain 2-3 ppm available chlorine. Citric acid was added daily as needed to maintain pH to 7.4 to 7.6. A control was performed using muriatic acid as the acidulant.

Daily test were done to monitor relative chlorine stability and availability. A Taylor Swimming Pool test kit Model K2005 was used to determine free available and bound chlorine as well as periodic testing for water hardness, alkalinity and cyanurate. The water was circulated and filtered by a fish tank filter with 1 20 micron fiber filter in place of the activated carbon filter. Use of citrate as an acidulant provided chlorine stability and did not increase chloramine or combined chlorine levels. Citrate also provided buffering ability and clarity of the water.

### Example 2

A citric acid composition of the present invention in an automatic pH control system was used in an outdoor pool. The pH was maintained very well with no adverse incidents and a noticeable increase in water clarity was remarked upon by experienced pool personnel.

### Example 3

With use in other pools, a citric acid composition was used for pH control. Fewer reportable accidents were reported when compared to muriatic acid usage which results in reports of spillage and splashing, and such reports with use of the citric acid composition had lesser consequences.

### Example 4

The present compositions are less deleterious to metal surfaces. Known samples of metal were soaked in like samples of muriatic and citric acids. The metal samples were electrodes from a salt chlorine generator. After 24 hours, each metal sample was re-weighed to discern any weight change. The sample soaked in citric acid showed less weight loss than the sample soaked in muriatic acid. Using citric acid composition as a pH adjuster is not as harmful to equipment, valves, heater exchangers and other metal components of swimming pools and spas.

### Example 5

Citric acid pH adjusting methods and compositions allowed for prevention of rapid pH changes. It is currently believed that citric acid provides a buffering capability. Measured amounts of a 100% citric acid composition were added to a sample of pool water to reduce the measured pH and total alkalinity. The results showed the bicarbonate alkalinity had been reduced and the citrate buffering had increased and prevented the pH from getting out of the normal accepted range.

### Example 6

A sample of water with a measured level of sodium bicarbonate and a sample of water with a measured level of sodium citrate were both heated to 104° Fahrenheit and held at that temperature for one hour. The bicarbonate sample lost alkalinity and the pH was elevated. The citrate sample lost little buffering ability and the pH changed only slightly.

### Example 7

Citric acid was measured and added to a known chelating compound, such as a cationic polymer, HEDP. The result was a composition with better stain and metal control which worked faster and required less product.

1. A method for establishing the pH in confined water, comprising,
a) adding an effective amount of a composition comprising an organic acid and borate or boric acid to a confined body of water, and
b) testing the resulting pH of the water.

2. The method of claim 1 in which the organic acid is a alkyl dicarboxylic acid of the form HO₂C(CH₂)ₙCO₂H wherein n may be 1, 2, 3 or 4.

3. The method of claim 1 in which the organic acid is RC(CH₂CO₂H)CO₂H wherein R may be —H, —OH, or —CH₃.

4. The method of claim 3 in which the organic acid is citric acid.

5. The method of claim 1 in which the organic acid may be either ethylenediamine tetraacetic acid or ethylene-bis(beta-aminoethylether)-N,N-tetraacetic acid.

6. The method of claim 1 in which the organic acid is an alpha amino acid containing a gamma carboxylic acid group.

7. The method of claim 6 in which the alpha amino acid may be either aspartic acid or glutamic acid.

8. The method of claim 1, wherein the composition is a dry powder comprising 80 to 100% organic acid, and 0-20% borate or boric acid.

9. The method of claim 8, wherein the dry powder composition comprises 95% citric acid and 5% boric acid.

10. A method for establishing the pH in a confined body of water, comprising,
a) adding to a confined body of water an effective amount of a composition comprising a food-safe organic acid recognized as GRAS; and
b) testing the pH of the water.

11. The method of claim 10, wherein the food-safe organic acid recognized as GRAS is citric acid.

12. The method of claim 10, wherein the composition further comprises borate or boric acid.

13. The method of claim 10, wherein the food-safe organic acid is in a concentration of 80-100%.

14. The method of claim 12, wherein the concentration of borate or boric acid is 0 to 20%.

15. The method of claim 12, wherein the composition optionally comprises fragrances, emulsifiers, or anti-caking compounds.

16. The method of claim 12, wherein the composition comprises borate and boric acid in a ratio of 5% to 95% borate to boric acid by weight.

17. The method of claim 12, wherein the composition is a dry powder of 95% citric acid and 5% boric acid.

18. A method for maintaining the pH of a swimming pool or spa, comprising,
a) testing the pH of a swimming pool or spa;
b) optionally, adding to a swimming pool or spa an effective amount of a composition comprising a food-safe organic acid recognized as GRAS to bring the confined body of water to a desired pH; and
c) testing the pH of the water.

19. The method of claim 18, wherein the food-safe organic acid recognized as GRAS is citric acid.

20. The method of claim 18, wherein the composition further comprises borate or boric acid.
